(19) United States
(12) Patent Application Publication
(10) Pub. No.: US 2007/0159338 A1
(43) Pub. Date: Jul. 12, 2007

(54) Hybrid Radio Frequency Identification (RFID) Tag System

(75) Inventors: Michael H. Beber, Plano, TX (US); Benjamin D. Donohue, McKinney, TX (US); Rajinder Bridgelall, Plano, TX (US); Allan R. Griebenow, Plano, TX (US); Michael A. Klinke, Dallas, TX (US)

Correspondence Address: BAKER BOTTS L.L.P., 2001 ROSS AVENUE, SUITE 600, DALLAS, TX, 75201-2980, US

(73) Assignee: Axcess International Inc., Carrollton, TX (US)

(21) Appl. No.: 11/615,743

(22) Filed: Dec. 22, 2006

Related U.S. Application Data
(60) Provisional application No. 60/753,638, filed on Dec. 22, 2005.

(51) Int. Cl. G08B 13/14

(52) U.S. Cl. 340/572.8

(57) ABSTRACT

In certain embodiments, a hybrid radio frequency identification (RFID) tag, includes one or more backscattering RFID elements operable to transmit and receive communications to and from a first tag tracking system at a first frequency range, the one or more backscattering RFID elements operable to transmit communications to the first tag tracking system using backscattering of a particular communication received from the first tag tracking system. The hybrid RFID tag further includes one or more active RFID elements operable to transmit and receive communications to and from a second tag tracking system at a second frequency range and operable to transmit communications to the second tag tracking system at the second frequency range with the use of a local power supply. A local power supply is coupled to the one or more active RFID elements.

### RELATED APPLICATION

This application claims priority under 35 U.S.C. § 119(e) of provisional application Ser. No. 60/753,638 filed Dec. 22, 2005.

### TECHNICAL FIELD

This invention relates in general to radio frequency identification (RFID) systems, and more particularly to a hybrid RFID tag system.

### BACKGROUND

The management and tracking of personnel, assets, and other objects is required in a wide variety of environments and is often cumbersome, labor intensive, and expensive. Radio receivers and transmitters have been used for many years to identify personnel and objects in such environments. For example, many systems are known for attaching radio tags to items, such as personnel, assets, and automobiles. When automobiles equipped with radio tags enter a certain area, such as a toll booth area, the automobiles are automatically identified. The appropriate tolls are deducted from corresponding accounts, thereby eliminating the need for drivers to stop and make payments at toll booths. When radio tags are place on personnel, they can be automatically identified and checked for authorized entry to a facility in a security application called access control. Assets which are tagged can be identified and tracked as they move throughout a facility for the purposes of automatically locating them. They can also be automatically counted therefore providing inventory control. They can also be protected as when an asset approaches an exit doorway the system can automatically determine if the asset is authorized to be removed from the facility. Tagged vehicles, assets, and personnel can be linked logically in the system to enable greater visibility and control.

RFID systems generally use a fixed position transmitter capable of reading remote, portable tags attached to personnel, assets, or other objects. Because of power consumption concerns and the life span of the tag, the radio tag often operates only after receiving a wake up signal, often called semi-active operation. The wake up signal is generated by a powered device called an activator which transmits the desired signal through a specially designed antenna based upon the physical properties of the area. Activation causes the tag to leave a low power state (e.g., a sleep state) and enter an active state. The activation transmitter produces the wake up signal, and an antenna transmits the wake up signal to a particular area.

Although semi-active radio tags are common, many applications alternatively use passive radio tags. Passive tags are tags that do not contain a battery. Instead, power for the tag is supplied by the tag reader (radio waves from the reader cause a magnetic field to be formed around the antenna of the tag, and the field is used to energize the circuits in the tag). One particular application of passive radio tags is in association with the EPCglobal or ISO 18000-6 standard. This standard pairs the use of RFID systems with electronic product codes (EPCs) for management of high volume consumer package goods. This standard is effective at automatically identifying pallets, cartons, and individual items as they enter a warehouse facility via an entry/exit door portal. The current standard is limited in its use and reliability because the passive RFID system solution requires substantial tag activation electronics to be located proximate to the tagged goods in order for the tag to have enough reflective energy for the signal to be read. Furthermore, careful orientation of tag to reader is a paramount concern in order to achieve reasonable performance. The result is a limited tag-to-reader range.

### SUMMARY

According to the present invention, disadvantages and problems associated with previous RFID tag systems and methods may be reduced or eliminated.

In certain embodiments, a hybrid RFID tag, includes one or more backscattering RFID elements operable to transmit and receive communications to and from a first tag tracking system at a first frequency range, the one or more backscattering RFID elements operable to transmit communications to the first tag tracking system using backscattering of a particular communication received from the first tag tracking system. The hybrid RFID tag further includes one or more active RFID elements operable to transmit and receive communications to and from a second tag tracking system at a second frequency range and operable to transmit communications to the second tag tracking system at the second frequency range with the use of a local power supply. A local power supply is coupled to the one or more active RFID elements.

In certain embodiments, a hybrid RFID tag includes one or more passive RFID elements operable to transmit and receive communications to and from a first tag tracking system at a first frequency without the use of a battery. The hybrid tag also includes one or more semi-active RFID elements operable to transmit and receive communications to and from a second tag tracking system at a second frequency with the use of a battery and upon receiving a wake-up signal from the second tag tracking system. The tag further includes a battery coupled to the one or more semi-active elements.

Particular embodiments of the present invention may provide one or more technical advantages. In certain embodiments, the hybrid RFID tag of the present invention can operate in a variety of tracking systems, according to a variety of suitable standards, each having its own benefits and limitations. This may provide the flexibility for interoperability among different types of tracking systems and standards, which may provide the user of the hybrid RFID tag with a tag that can be used in virtually any tracking system. Accordingly, certain embodiments of the hybrid RFID tag may bridge the gap between non-compatible RFID technologies, which may allow roaming among various tracking systems. For example, the roaming may be from a passive EPC Generation II environment to ultra-high frequency (UHF) and low frequency (LF) networks across regulatory boundaries worldwide.

Certain embodiments of the present invention may provide some, all, or none of the above advantages. Certain embodiments may provide one or more other technical advantages, one or more of which may be readily apparent to those skilled in the art from the figures, descriptions, and claims included herein.

### BRIEF DESCRIPTION OF THE DRAWINGS

For a more complete understanding of the present invention and its advantages, reference is made to the following descriptions, taken in conjunction with the accompanying drawings, in which:

FIG. 1 illustrates an example RFID system that includes one or more hybrid RFID tags, according to certain embodiments of the present invention;

FIG. 2 illustrates another example RFID system, along with additional details of an example hybrid RFID tag, according to certain embodiments of the present invention; and

FIG. 3 illustrates example details of an example hybrid RFID tag, according to certain embodiments of the present invention.

### DESCRIPTION OF EXAMPLE EMBODIMENTS

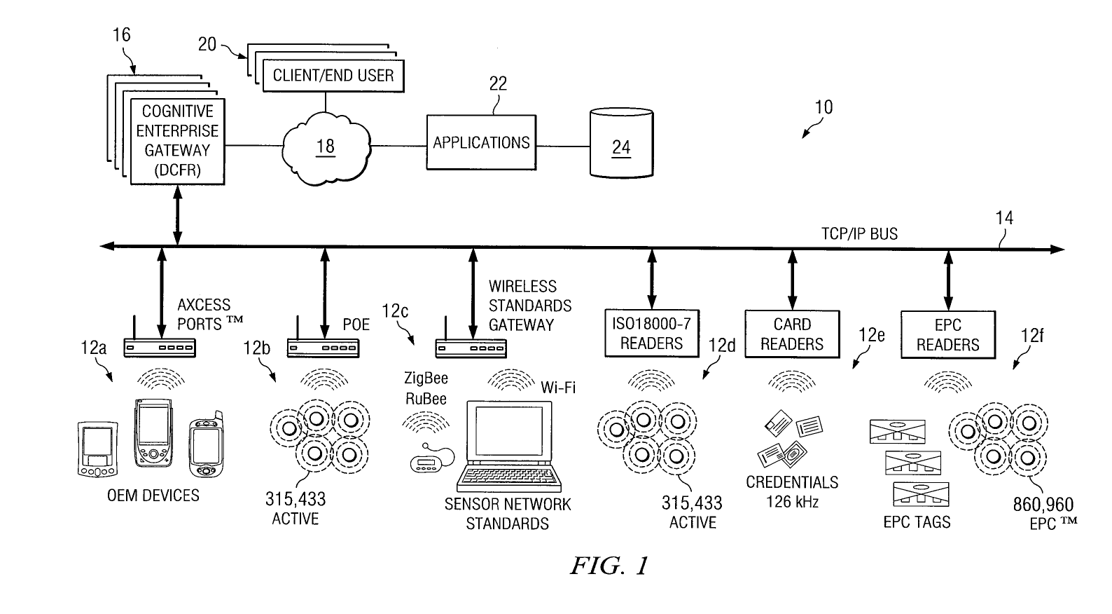

FIG. 1 illustrates an example RFID system 10 that includes one or more hybrid RFID tags, according to certain embodiments of the present invention. RFID system 10 may be used to track and identify objects or persons by attaching a transponder, or radio tag, to each object or person being tracked, or for any other suitable purpose. According to certain embodiments of the present invention, this transponder or radio tag may be a hybrid RFID tag. RFID system 10 communicates at one or more wireless frequencies, including low frequencies (LF), very low frequencies (VLF), very high frequencies (VHF), ultra-high frequencies (UHF), microwaves, or other suitable frequencies. Each hybrid RFID tag is a remote, portable, self-contained device that may be affixed to a moveable item, such as a person, inventory, or a vehicle. Although a particular example implementation of system 10 is illustrated in and described with respect to FIG. 1, the present invention contemplates any suitable implementation of system 10 according to particular needs.

In general, passive tags cannot provide accurate inventory accounting of goods that require a longer read range. Furthermore, these tags also cannot independently provide sensing information. They also cannot independently provide theft protection, tracking, or static inventory counting. These functions may be obtained in certain circumstances using active tags. Active tags use batteries to provide regular beacon signals for automatic identification at long ranges using a flexible receiver infrastructure. Alternatively, semi-active tags may also be used. Such semi-active tags may be awakened using low cost open air tag activation at lower RF frequencies (such as 126 KHz) so that the tag does not have to constantly transmit and can therefore preserve its battery strength. However, active tags and semi-active tags cannot economically provide high volume portal accounting, such as the management of goods under the EPCglobal standard.

When combined into a single RFID tag, however, various elements of passive, semi-active, and active RFID tags can provide benefits beyond the individual capabilities of each type of tag. Therefore embodiments of the present invention use selected features of each tag type and match them to the unique needs of the end user to provide a unique and advantageous hybrid RFID tag that may include a combination of passive, semi-active, and/or active RFID tag capabilities. For example, the hybrid RFID tag of the present invention incorporates aspects of the two or more of a passive tag, a semi-active tag, and an active tag into a single tag. In certain embodiments, this hybrid RFID tag is a multifunctional system-on-a-chip (SOC) made to be embedded into a variety of products such as laptops, medical devices, personnel credentials, and pallet tags. The hybrid RFID tag may be very small, such as the size of a penny for example. The hybrid RFID tag is battery powered to provide long-range, reliable radio frequency signals and incorporates sensors and wireless mesh networks. In certain embodiments, the flexibility for the interoperability is due to the software definable transceiver communications that may support standards such as EPC Generation II and proprietary protocols for active RFID and real-time locator system (RTLS). The hybrid RFID tag may be customizable in that the tag may include ports for sensors and memory storage for data logging, pedigrees, and other devices.

System 10 includes example tracking systems 12 with which hybrid RFID tags may be used. Although referred to as “tracking systems,” tracking systems 12 may be any suitable system or environment in which hybrid RFID tags may be used. Hybrid RFID tags may be able to operate in any number of tracking systems 12.

System 10 includes a number of tracking systems 12, each operable to transmit messages to and receive messages from hybrid RFID tags. Each tracking system 12 may include one or more base stations that communicate with one or more RFID tags by an analog signal at a specified radio frequency.

Each base station may include one or more of a tag detector, a control system, and a base station antenna. The tag detector may include a tag reader and/or an activator. The control system, which may be local or remote to the tag detector and the antenna, may be implemented as a mainframe or other stand alone computer, server, personal computer, or any other type of computing device capable of controlling operation of the base station. The base station antenna may transmit and receive signals on various radio frequencies as necessary to provide communications between the base station and the hybrid RFID tags. The reader may acquire incoming signals from the base station antenna and demodulate the incoming signal for processing by the control system. The reader may also modulate signals generated by the control system onto a carrier wave and transmit the modulated signal through the base station antenna as an analog communicated signal.

Signals are used within RFID system 10 to transmit messages between base stations of tracking systems 12 and the hybrid RFID tags. Communicated signals destined for a specific hybrid RFID tags or the base station are referred to as explicit communications since a specific destination device is referenced in the message. Other messages may be transmitted between the base stations and all RFID tags within RFID system 10. These communications are referred to as non-explicit, or global, communications since the message is not directed at a specific RFID tag and requires a response or other suitable action from each RFID tag receiving the message. Throughout this description, the term “signal” and “communication” may be used interchangeably.

An activator may comprise a stand-alone transmitter that connects directly to an application-specific antenna (e.g., Plex Overhead Ceiling) to provide an activation signal that awakens certain RFID tags or tag elements as those tags move through a designation control point. The activator may writes its location identity to the tag, which is then re-transmitted by the receiving tag, along with the tag's unique identity, to provide the tag's precise location at the time of activation. By adjusting the power output on the activator, the activation area footprint can be expanded or reduced. The activator can be configured with its own user-defined location identity via serial port (using a PC or terminal communications device) or manually via jumpers. The unit installs easily and offers flexible coverage for perimeter doors such as in this application. A tag reader may be used to interact with passive tags or passive tag elements. Passive tags may be activated and read by hardware installed at the control point and tuned to their 860 MHz-960 MHz frequency requirements.

In certain embodiments, analog communicated signals contain a message that requests a hybrid RFID tag to perform some action such as responding to a query or forwarding a message. The analog communicated signals also contain a wakeup signature that precedes each message and informs the receiving hybrid RFID tag to prepare to receive an incoming message. In certain embodiments, each radio tag includes logic and circuitry for retransmission of signals received from a base station. As used herein, the term each means every one of at least a subset of the identified items. Each hybrid RFID tag has one or more associated operational ranges that define the area in which signals transmitted by the hybrid RFID tag may be received by other devices such as a base station. If a hybrid RFID tag receives an explicit communication from a base station that identifies that hybrid RFID tag as the destination, that hybrid RFID tag may process the message and transmit a response to the base station.

The tracking systems illustrated in FIG. 1 are merely example tracking systems that may be used with the hybrid RFID tag of the present invention. Additionally, the present invention contemplates system 10 including one, some, or all of the example tracking systems illustrated in FIG. 1. Moreover, the hybrid RFID tag may be used with tracking systems other than those illustrated in FIG. 1. The example tracking systems illustrated in FIG. 1 are described in more detail below.

Tracking system 12a comprises an AXCESS PORTS system manufactured by AXCESS INTERNATIONAL, INC., which may operate with one or more suitable original equipment manufacturer (OEM) devices that each include a hybrid RFID tag. Tracking system 12a may be designed to communicate primarily with the active element of a hybrid RFID tag, although the present invention is not intended to be so limited.

Tracking system 12b comprises a power-over-Ethernet (POE) system, which may operate with one or more suitable devices that each include a hybrid RFID tag. Tracking system 12b may be designed to communicate primarily with the active element of a hybrid RFID tag in the frequency range of approximately 315 MHz to approximately 433 MHz, although the present invention is not intended to be so limited.

Tracking system 12c comprises a wireless communication standards gateway. For example, one or more mobile devices may communicate in tracking system 12c using Wi-Fi standards, ZigBee, Rubee, or any other suitable standards. Tracking system 12c may be designed to communicate primarily with the active element of a hybrid RFID tag, although the present invention is not intended to be so limited.

Tracking system 12d comprises a non-proprietary, active tag standard system. For example, tracking system 12d comprises one or more ISO/IEC 18000-7 compliant tag readers operable to transmit primarily to and receive messages primarily from one or more active elements of hybrid RFID tag-enabled devices in the frequency range of approximately 315 MHz to approximately 433 MHz, although the present invention is not intended to be so limited.

Tracking system 12e comprises a system for communicating with cards, such as proximity access control cards. Tag readers for such systems typically communicate with passive RFID tags at a low frequency. For example, tag readers for such systems may communicate with the passive element of a hybrid RFID tag at approximately 126 kHz. In certain embodiments, these tag readers communicate with passive RFID tags using near-field, inductively coupled backscattering.

Tracking system 12f comprises an EPC-compliant system operable to read EPC-compliant RFID tags. In certain embodiments, tag readers of tracking system 12f are operable to communicate with the passive tag element of a hybrid RFID tag, although the present invention is not intended to be so limited. Additionally or alternatively, tag readers of tracking system 12f are operable to communicate with either or both of the active or semi-active tag elements of a hybrid RFID tag.

The various tracking systems 12 illustrated in FIG. 1 are designed to communicate with RFID tags at various corresponding frequency ranges and according to particular standards. For example, certain tracking systems 12 are designed to communicate with active RFID tags at frequencies generally in the range of approximately 433.92 MHz, 315 MHZ, and/or 900 MHz. As another example, certain tracking systems 12 are designed to communicate with semi-active RFID tags at frequencies generally in the range of approximately 860 MHz to approximately 960 MHz. As another example, certain tracking systems 12 are designed to communicate with passive RFID tags at frequencies generally in the range of approximately 860 MHz to approximately 960 MHz. Although these particular frequency ranges are described, the present invention contemplates communications between tracking systems 12 and each of active RFID tags, semi-active RFID tags, and passive RFID being at any suitable frequency according to particular needs. Because hybrid RFID tags include a combination of passive tag elements, semi-active tag elements, and active tag elements, hybrid RFID tags may be operable to function in two or more of these tracking systems 12.

System 10 may include a system link 14, which in one example comprises a Transmission Control Protocol (TCP)/Internet Protocol (IP) bus. In certain embodiments, link 14 may include one or more computer buses, local area networks (LANs), metropolitan area networks (MANs), wide area networks (WANs), a global computer network such as the Internet, or any other wireline, optical, wireless, or other links. Although a single link 14 is illustrated and primarily described, the present invention contemplates system 10 including any suitable number of links 14. The tag readers of the various tracking systems 12 are operable to transmit information received from the hybrid RFID tags over link 14.

System 10 may include one or more cognitive enterprise gateways 16. Cognitive enterprise gateway 16 is operable to receive (e.g., via link 14) the data that the tag readers of tracking systems 12 gather from the hybrid RFID tags. Cognitive enterprise gateway 16 is further operable to translate that data, which may include normalizing the data received from the different tracking systems 12. An example cognitive enterprise gateway is the Data Collection Filtering and Routing (DCFR), although the present invention contemplates system 10 including any suitable types of cognitive enterprise gateways.

System 10 may include a network 18. Network 18, which may couple user system 12 to databases 14, may include one or more local area networks (LANs), metropolitan area networks (MANs), wide area networks (WANs), radio access networks (RANs), a global computer network such as the Internet, or any other wireline, optical, wireless, or other links. Network 18 may communicate, for example, IP packets, Frame Relay frames, or Asynchronous Transfer Mode (ATM) cells to communicate voice, video, data, and other suitable information between network addresses.

System 10 may include one or more client systems 20, which may include one or more computer systems at one or more locations. Each computer system may include any suitable processing device such as a personal computer, laptop computer, personal digital assistant (PDA), cellular telephone, or any other suitable processing device.

System 10 may include one or more applications 22. Applications 22 may process data received from hybrid RFID tags. Users of clients systems 20 may access applications 22 to interact with the gathered data. Applications 22 may be stored on clients systems 20, on a server system accessible to client systems 20, or on any other suitable device. Applications 22 may include control software. The control software used may be e/OLS software manufactured by AXCESS INTERNATIONAL, INC. or any other suitable software. The e/OLS software is designed to integrate passive and active tag reads for event-based logging, monitoring, alarming, and record-keeping. In addition, e/OLS may provide “function linkage” of assets, personnel and/or vehicles that logically “links” single or multiple assets or vehicles to one or more passive tag elements. In addition, e/OLS may provide interface-to-sensor control systems through standard and custom or hardwire connections to provide system level integration of the sensors with the other identified system elements, alarms and controls. Furthermore, e/OLS may provide an interface to media systems to provide system level integration of the media systems with the other identified system elements. e/OLS may provide management information, such as: general activity information, time and attendance information, asset status, movement history, functional linkage violations information and unauthorized asset movement data. e/OLS may processes tag reads from the control point receivers sent over network 18.

System 10 includes one or more databases 24, referred to throughout the remainder of this description in the singular. Database 24 may store information gathered from hybrid RFID tags. Additionally or alternatively, database 24 may store information determined based on information gathered from hybrid RFID tags. For example, database 24 may store information determined by one or more applications 22. Database 24 may include any memory or database module and may take the form of volatile or non-volatile memory including, without limitation, magnetic media, optical media, random access memory (RAM), read-only memory (ROM), removable media, or any other suitable local or memory component. In particular embodiments, database 24 includes one or more SQL servers. Although described as a database, database 24 may include any suitable type of memory module.

Particular embodiments of the present invention may provide one or more technical advantages. In certain embodiments, the hybrid RFID tag of the present invention can operate in a variety of tracking systems 12, according to a variety of suitable standards, each having its own benefits and limitations. This may provide the flexibility for interoperability among different types of tracking systems 12 and standards, which may provide the user of the hybrid RFID tag with a tag that can be used in virtually any tracking system 12. Accordingly, certain embodiments of the hybrid RFID tag may bridge the gap between non-compatible RFID technologies, which may allow roaming among various tracking systems 12. For example, the roaming may be from a passive EPCGlobal Generation II environment to UHF and LF networks across regulatory boundaries worldwide.

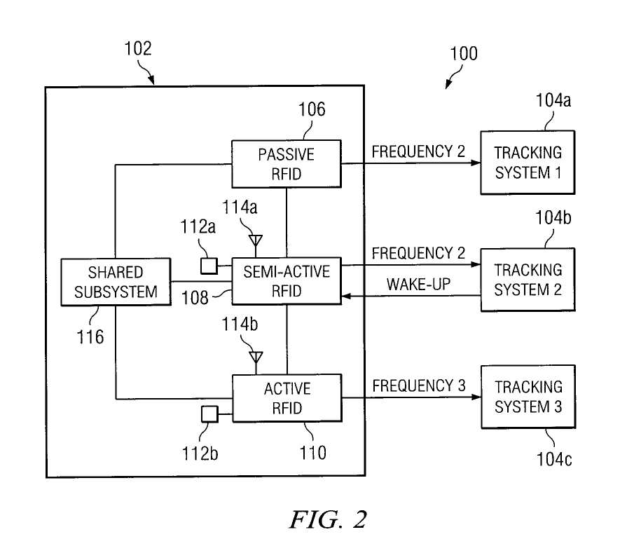

FIG. 2 illustrates another example RFID system 100, along with additional details of an example hybrid RFID tag 102, according to certain embodiments of the present invention. System 100 includes example RFID tag 102 and a plurality of tracking systems 104. Although this particular implementation of RFID system 100 is illustrated and primarily described, the present invention contemplates any suitable implementation of RFID system 100, according to particular needs. Additionally, although this particular implementation of hybrid RFID tag 102 is illustrated and primarily described, the present invention contemplates any suitable implementation of RFID tag 102, according to particular needs.

In certain embodiments, hybrid RFID tag 102 includes logic and circuitry for retransmission of signals received from a tracking system 104 and possibly other RFID tags. In certain embodiments, hybrid RFID tag 102 comprises an integrated circuit. Hybrid RFID tag 102 may include any suitable combination of hardware, firmware, and software.

Hybrid RFID tag 102 includes a passive RFID element 106, a semi-active RFID element 108, and an active RFID element 110. Although the example hybrid RFID tag 102 illustrated in FIG. 2 comprises each of passive RFID element 106, semi-active RFID element 108, and active RFID element 110, the present invention contemplates hybrid RFID tags that include any combination of two or more of passive RFID element 106, semi-active RFID element 108, and active RFID element 110. For example, hybrid RFID tag 102 may include passive RFID element 106 and semi-active RFID element 108. As another example, hybrid RFID tag 102 may include passive RFID element 106 and active RFID element 110. As yet another example, hybrid RFID tag 102 may include semi-active RFID element 108 and active RFID element 110. Moreover, although hybrid RFID tag 102 is illustrated and described as including a particular number of passive RFID elements 106, semi-active RFID elements 108, and active RFID elements 110, the present invention contemplates hybrid RFID tag 102 including any suitable number of passive RFID elements 106, semi-active RFID elements 108, and active RFID elements 110. It should be understood that the hybrid RFID tag of certain embodiments of the present invention may be a single tag structure that comprises any suitable combination of these different tag types.

Hybrid RFID tag 102 may include one or more local power supplies 112. Although a particular number of local power supplies 112 are illustrated and primarily described, hybrid RFID tag 102 may include any suitable number of local power supplies 112. For example, semi-active RFID element 108 may be coupled to or otherwise include a first local power supply 112a, and active RFID element 110 may be coupled to or otherwise include a second local power supply 112b. In embodiments in which hybrid RFID tag 102 includes multiple local power supplies 112, the local power supplies 112 may be identical to one another or may vary in type. Each local power supply 112 may include one or more of a battery, a solar cell system, a heat flow transducer, or any other suitable portable power source.

Hybrid RFID tag 102 may include one or more antennas 114, referred to primarily in the singular throughout the remainder of this description. Although a particular number of antennas 114 are illustrated and primarily described, hybrid RFID tag 102 may include any suitable number of antennas 114. For example, each of passive RFID element 106, semi-active RFID element 108, and active RFID element 110 may be associated with its own antenna 114, or two or more of passive RFID element 106, semi-active RFID element 108, and active RFID element 110 may share a single antenna 114. Antenna 114 is operable to facilitate the receipt and transmission of communications from and to tracking systems 104.

Passive RFID element 106 is operable to transmit messages to and receive messages from a first tracking system 104a at a first frequency range. Passive RFID element 106 is operable to transmit messages to tracking system 104a without using a local power supply 112. For example, passive RFID element 106 is operable to receive a communication from tracking system 104a and to use backscattering to generate and transmit a response communication. Throughout this description, a backscattering element refers to components that are operable to transmit messages using backscattering. Certain passive RFID elements 106 may be backscattering elements. In certain embodiments, a backscattering element, such as passive RFID element 106, is operable to use the energy from an incoming communication (e.g., from tracking system 104a) to modulate a fixed response onto the incoming communication and forward that communication with the modulated response back to the sending device (e.g., tracking system 104a). The operational range of passive RFID element 106 is necessarily limited due to its lack of a local power supply 112.

One type of passive RFID element 106 that may be used is an EPC™compliant passive RFID element that meets the EPCglobal Generation 2 standard. This EPCglobal standard is expected to be used as a base platform upon which RFID readers and tags and future improvements can be built, ensuring complete interoperability and setting minimum operational expectations for various components in the EPCglobal network, including the various necessary hardware components and software components.

Semi-active RFID element 108 is operable to transmit messages to and receive messages from a second tracking system 104b. Unlike passive RFID element 106, semi-active RFID element 108 is associated with a local power supply 112a. This local power supply 112a may be used to provide power to the chip for generating a response to an incoming communication (e.g., from tracking system 104b). Local power supply 112a may allow semi-active RFID element 108 to generate a stronger response to incoming communications relative to passive RFID element 106, since semi-active RFID element 108 is not entirely dependent on the incoming communication to provide the power for generating a response. As a particular example, semi-active RFID element 108 may receive a wake-up signal from tracking system 104b, which may cause semi-active RFID element 108 to leave a low power or sleep state and enter an active state. Semi-active RFID element 108 may then use its local power supply 112a to generate and transmit a response communication to tracking system 104b.

Active RFID element 110 is operable to transmit messages to and receive messages from a third tracking system 104c. Active RFID element 110 is associated with a local power supply 112b. Active RFID element 110 is operable to transmit and receive communications to and from tracking system 104c using local power supply 112b. Active RFID element 110 may include the internal processing capability to determine an appropriate response to an incoming message. Active RFID element 110 may then transmit the response at a high power (i.e., due to local power supply 112b), thereby increasing the operational range of the active RFID element 110 as compared to passive RFID element 106, which does not contain a local power source 112, and even compared to semi-active RFID element 108. Active RFID element 10 may transmit when activated at a control point (e.g., of tracking system 104c). An additional optional feature may allows active RFID element 110 to automatically transmit on a preprogrammed timed interval to assist in the location and tracking of escorts and transport cases across broad areas within the designated area provided appropriate supporting network receivers are installed in appropriate locations.

Since both semi-active RFID element 108 and active RFID element 110 are operable to transmit messages using a local power supply 112, both semi-active RFID element 108 and active RFID element 110 may each constitute an active RFID element. In certain embodiments, a distinction between a semi-active RFID element 108 and active RFID element 110 is that semi-active RFID element 108 transmits communications using its local power supply 112a after receiving a wake-up communication from its associated tracking system 104b, while active RFID element 110 may transmit communications using its local power supply 112b without receiving a wake-up signal.

Each of passive RFID element 106, semi-active RFID element 108, and active RFID element 110 has an associated operational range that defines the area in which signals transmitted by hybrid RFID tag 102 may be received by other devices such as tracking system 104. The frequency ranges for passive RFID element 106, semi-active RFID element 108, and active RFID element 110 may overlap, be substantially the same, or be entirely distinct, according to particular needs.

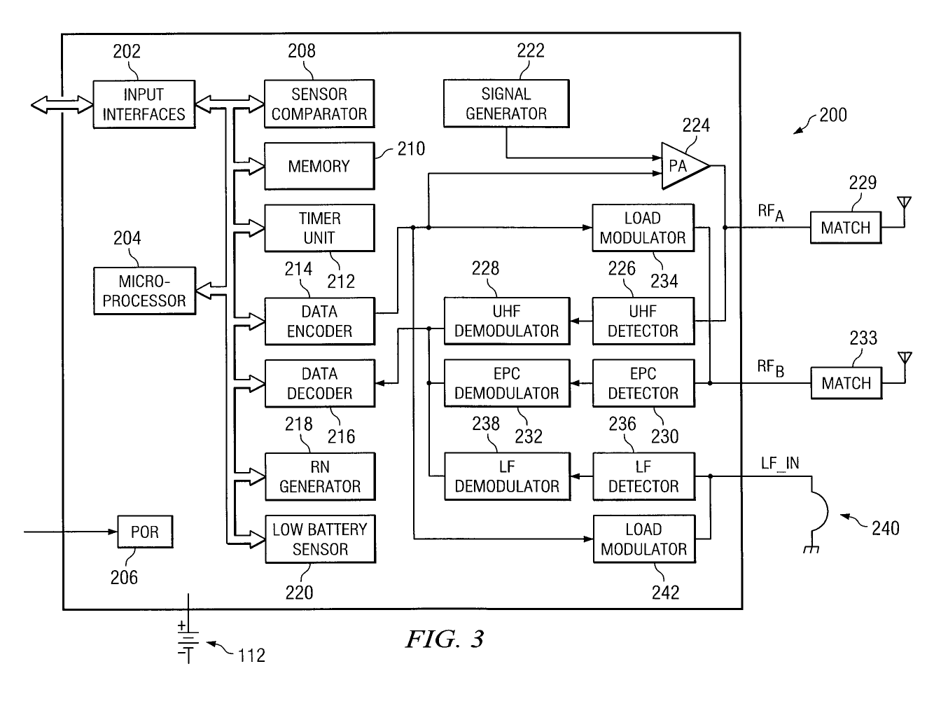

The frequency spectrum includes three general ranges of frequencies suitable for RFID system applications. These ranges include kilohertz frequencies on the low end of the spectrum up to gigahertz frequencies at the high end of the spectrum. At the low end of the spectrum are very low frequencies (VLF) and LFs. The VLF/LF frequencies have limited range, but signals transmitted on these frequencies are very controllable. Thus, they are particularly useful for applications requiring controlled transmission of signals to a specific geographic area. An example of an application for VLF/LF frequencies are providing wakeup signals to radio tags as they enter a specific area. The VLF/LF frequencies are generally not suitable for transmitting signals back to the base station since radio tags have insufficient power to overcome noise and other interference present in these frequency ranges. However, in certain embodiments of the present invention (as will be described in greater detail below with reference to FIG. 3), hybrid RFID tag is operable to both receive and transmit communications at VLF/LF frequencies.

The middle of the frequency spectrum includes very high frequencies (VHF) and UHF. These frequencies are characterized by low noise and reliable transmission. However, VHF/UHF frequencies cannot easily be directionally controlled. In addition, it is difficult to control range. Thus, these frequencies transmit in all directions. VHF/UHF frequencies are best suited for radio tag responses since the orientation between a base station of a tracking system and a hybrid RFID tag is irrelevant and signals may be transmitted at very low power since there is low noise present in these frequency ranges.

At the upper end of the frequency spectrum are microwaves. These frequencies can be made extremely directional and are very sensitive to environmental interference. Microwaves generally require a direct line of sight between transmitter and receiver. In general, microwave frequencies have limited application due to their extreme sensitivity to environmental interference. A specific application for microwave frequencies is an RFID tracking system 12 for a toll booth. Since microwaves are directional and can be focused, the base station of the tracking system 12 can transmit signals to a specific area where a vehicle, and thus its hybrid RFID tags, will enter as it proceeds through the toll booth.

Shared subsystem 116 of hybrid RFID tag 102 may include any suitable memory modules, processing modules, a substrate, sensor logic, and/or any other suitable components of hybrid RFID tag 102 that may be shared among the passive, semi-active, and active tag elements of hybrid RFID tag 102.

Although hybrid RFID tag 102 has many uses, it may be particularly useful in association with an EPCglobal network or other electronic product code or similar standards.

By adding battery power to the passive tag, items with tags that move through a passive tag wake-up field can have their tags pre-programmed and their circuits pre-charged for a faster and stronger return signal using the power of the on-board battery. Improved EPC portal reliability results particularly with items for which the use of passive tags is problematic, such as metal containers or containers holding fluids, items where the tag is angled away from the direct line of sight of the reader, and/or items where tags are not directly in line with the reader.

In addition, tags according to certain embodiments include the ability to transmit and receive information at multiple frequencies. For example, such a tag may be able to transmit and receive in the EPCglobal frequency range (for example, 860-960 MHz) and may also be able to communicate in typical active tag frequencies (such as 433.92, 315, or 900 MHz). Therefore, for example, if the passive elements of the tag are unable to receive an adequate signal from an EPCglobal tag reader (and thus are unable to receive power), then the active or semi-active components of the tag can be used to receive and transmit information to the EPCglobal system.

Furthermore, hybrid tags according to particular embodiments may include an anti-tamper function. For example, this may be useful for goods where EPCglobal standard passive tagging is desired, but where the performance of such passive tags is not acceptable due to a lack of line of sight. A hybrid RFID tag can wake up using the EPC reader, and with battery assistance it can be read by the existing passive EPC infrastructure. Tags can be placed on carton and pallet openings in order to sense tampering and when a tamper is evident, the condition can be relayed to the system. Receivers in an active tag infrastructure can receive the tamper signal transmitted by a tag. A receiver decodes the incoming RF signal and, along with other receivers, communicates the signal over a network to a central computer (for example, as described in U.S. Pat. Nos. 6,034,063 and 6,570,487, which are incorporated herein by reference). In addition, anti-theft detection can be accomplished using a hybrid tag. Products that have already been read by the EPC passive system and are already residing in the warehouse can have anti-tamper protection whereby the active tag portion of the tag can be awakened upon an attempt to remove the product through any doorway. Using the active RFID wake-up field capability (for example, at 126 kHz), the tag will wake-up as it moves out an unauthorized doorway and, if not pre-authorized by the system, it can transmit an alarm oriented message to the active reader system and appropriate human intervention initiated.

Moreover, hybrid tags according to particular embodiments can include environmental or other suitable sensors and can be programmed to enable dynamic sensor readings using the tag with or without the EPCglobal (or a similar EPC) infrastructure. For example, an “out-of-limits” temperature or humidity condition or other real-time sensor event readings can trigger an alarm based upon a pre-defined alert level. The alarm can be transmitted to either the existing EPC standards-based infrastructure or the separate active RFID infrastructure. Where a sensor is required on a side of the asset, but not directly located in the line of sight to the passive reader, the hybrid RFID tag's superior transmission capability may enable the tag's signal to reach the EPC standard reader reliably upon moving through the normal dock door configuration.

In a particular example application of the present invention, suppose that a hybrid RFID tag 102 is attached to a pallet of bananas, allowing the pallet of bananas to be monitored and tracked. Assume also that this example hybrid RFID tag 102 comprises an active RFID element 110 and a passive element 106, passive element 106 being EPC-compliant. When the pallet is brought into a warehouse, the EPC tag reader begins the tracking of the pallet, including the tracking of the temperature. The pallet may then be removed from the warehouse and loaded onto a truck for delivery. The truck will likely be temperature controlled to help ensure that the bananas do not ripen too soon. Suppose in this example that the temperature control mechanism fails in the truck fails. Because the passive element 106 of the hybrid RFID tag 102 is reliant on the reader for power, the passive element 106 may not report the failure of the temperature control mechanism. The hybrid RFID tag of the present invention allows the active RFID element 110 tag to, on its own, transmit an alert, to a central station and/or the driver for example, indicating that there has been a temperature failure. Thus, while it is desirable for a tag to be EPC-compliant for a variety of reasons, the ability to use the active tag element 110 of the same tag can provide greater capabilities for the tag.

Furthermore, hybrid tags according to certain embodiments may support on-demand queries for status, location, and inventory counting. Such queries can be initiated and the response from the tag can be read and collected with the EPC infrastructure or with the active RFID infrastructure. Inventory counting can be accomplished by beaconing a transmit signal on a regular basis using the hybrid tag where the signal is received by the proprietary infrastructure. Receivers in the active RFID infrastructure receive the beacon signal transmitted by a tag. A receiver decodes the incoming RF signal and, along with other receivers, communicates the signal over a network to a central computer (for example, as described in U.S. Pat. Nos. 6,034,063 and 6,570,487). The beacon signal can also be sent to the EPC standards-based receiver infrastructure.

The tagging of personnel in the facility can be accomplished using a hybrid tag to track the whereabouts of personnel using the 126 kHz wake-up field (or other suitable frequency) to define a given location and the tag can transmit to the pre-existing EPC reader infrastructure thereby reducing overall infrastructure cost. The tracking of goods around a facility can be accomplished using activation (such as at 126 kHz) at doorways and strategic control points. Transmission of this tracking information to the active tag tracking infrastructure, such as the proprietary infrastructure identified above, can be accomplished at 433.92 MHz (or at any other suitable frequency) in order to enable long range transmission and therefore provide a flexible infrastructure. Similarly, the active wake-up can be used to establish the control point location with the tag transmission of the location data occurring to the 860-960 MHz EPCglobal receiver.

FIG. 3 illustrates example details of an example hybrid RFID tag 200, according to certain embodiments of the present invention. In certain embodiments, hybrid RFID tag 200 may be used in system 10 and/or system 100 illustrated in FIGS. 1 and 2, respectively, although the present invention contemplates hybrid RFID tag 200 being used in any suitable system, according to particular needs. Moreover, hybrid RFID tag 102 illustrated in FIG. 2 may include the details illustrated in FIG. 3 or may be constructed in any other suitable manner in accordance with the present invention.

Hybrid RFID tag 200 may include one or more input/output (I/O) interfaces 202. I/0 interfaces 202 may comprise general purpose I/O interfaces. In certain embodiments, I/O interfaces may interface one or more sensors, expansion memory modules, or any other suitable components. Example I/O interfaces may include a joint test action group (JTAG) interface, a universal asynchronous receiver transmitter (UART), and an I²C interface.

Hybrid RFID tag 200 may include one or more processing modules 204 (e.g., a microprocessor). Processing module 204 may include one or more processing units, which may include one or more microprocessors, controllers, or any other suitable computing devices or resources.

Hybrid RFID tag 200 may include a power-on/reset (POR) component 206, which may be operable to restore one or more components of RFID tag 200 (e.g., a storage device or other suitable memory module or a registry) to a predetermined state when power is applied.

Hybrid RFID tag 200 may include a sensor comparator 208, which may receive sensor input from one or more sensors associated with hybrid RFID tag 200 and may process the sensor input. In certain embodiments, sensor comparator 208 receives a voltage reading as the sensor input from the sensor and interprets that voltage reading. A non-limiting example sensor from which sensor comparator 208 may receive sensor input is a temperature sensor. Sensors used with hybrid RFID tag 200 may be included on hybrid RFID tag 200 or may be otherwise communicatively coupled to hybrid RFID tag 200.

Hybrid RFID tag 200 may include one or more memory modules 210. Each memory module 210 may take the form of volatile or non-volatile memory including, without limitation, magnetic media, optical media, random access memory (RAM), read-only memory (ROM), removable media, or any other suitable memory component.

Hybrid RFID tag 200 may include a timer unit 212, which is operable to provide general timer functions for processing. Hybrid RFID tag 200 may include a data encoder 214, which is generally operable to receive data in a first format, encode the data into a second format, and output the data in the second format. Hybrid RFID tag 200 may include a data decoder 216, which is operable to receive data in a first format, decode the data into a second format, and output the data in the second format. Hybird RFID tag 200 may include a random number (RN) generator 218, which may be used to provide security (e.g., for processing EPC signals). Hybrid RFID tag 200 may include a low battery sensor 220, which may trigger an alert when the power provided by local power supply 112 of hybrid RFID tag 200 drops below a predetermined threshold.

Hybrid RFID tag 200 may include a signal generator 222, which is operable to generate signals (e.g., communications) using one or more of a system clock generator, a phase-locked loop, and any other suitable circuitry and components. Hybrid RFID tag 200 may include a power amplifier (PA) 224 operable to apply a transfer function to an incoming signal, resulting in a gain. Signal generator 222 and data encoder 214 may provide inputs to power amplifier 224 to generate a communication for transmission from hybrid RFID tag 200, using antenna 114bfor example. This communication may be transmitted at the frequency of the active RFID element 110 of hybrid REID tag 200 (e.g., RFA).

Hybrid RFID tag 200 includes a UHF detector 226 and a UHF demodulator 228. In this example, UHF detector 226 and UHF demodulator 228 may comprise, at least in part, either or both of the semi-active RFID element 108 and active REID element 110 of hybrid RFID tag 200. Communications in a first radio frequency range (RFA) may be transmitted and received via antenna 114b. In a particular example, this first radio frequency range is approximately 860 MHz to approximately 960 MHz.

Hybrid RFID tag 200 may include a match component 229. In certain embodiments, match component 229 includes circuitry that provides a complex conjugate impedance match for maximum power transfer between its associated antenna and a radio frequency port.

Hybrid RFID tag 200 includes an EPC detector 230 and an EPC demodulator 232. In this example, EPC detector 230 and EPC demodulator 232 comprise, at least in part, a backscattering element of hybrid RFID tag 200. For example, EPC detector 230 and EPC demodulator 232 may comprise, at least in part, a passive element 106 of hybrid RFID tag 200. Communications in a second radio frequency range (RFB) may be transmitted and received via antenna 114a. In a particular example, this second radio frequency range is approximately 315 MHz to approximately 415 MHz.

Hybrid RFID tag 200 may include a match component 233. In certain embodiments, match component 233 includes circuitry that provides a complex conjugate impedance match for maximum power transfer between its associated antenna and a radio frequency port.

Hybrid RFID tag 200 may include a load modulator 234, which may allow communications to be sent at the second radio frequency (RFB). For example, load modulator 234 may receive a signal from data encoder 214 and may regulate the energy of the signal (e.g., using loop impedance) for communication at the second radio frequency. For example, load modulator may be operable to switch its associated antenna from an highly reflective state (e.g., for transmission of messages) to a highly absorptive state (e.g., for receipt of messages) and vice versa.

Hybrid RFID tag 200 includes an LF detector 236 and an LF demodulator 238. In this example, LF detector 236 and LF demodulator 238 may comprise, at least in part, a backscattering element of hybrid RFID tag 200, operable to communicate signals using backscattering. Additionally or alternatively, LF detector 236 and LF demodulator 238 may transmit signals using a local power supply. In certain embodiments, LF detector 236 and LF demodulator 238 may transmit messages using load modulation. Thus, in certain embodiments, the LF components of hybrid RFID tag 200 may operate in any of an active state (e.g., transmitting using the power of a local power supply), semi-active state (e.g., transmitting using a local power supply after receiving a wake-up signal), or passive (e.g., transmitting using backscattering). Communications in an LF (i.e., at LF_IN) may be transmitted and received via a detector coil 240, although any other suitable device for receiving and transmitting LF signals is contemplated by the present invention. In a particular example, this LF is approximately 126 kHz.

Hybrid RFID tag 200 may include another load modulator 242, which may allow communications to be sent at the LF. For example, load modulator 242 may receive a signal from data encoder 214 and may regulate the energy of the signal (e.g., using loop impedance) for communication at the LF.

In operation of an example embodiment of hybrid RFID tag 200, a communication may be received from a first tracking system at a first frequency (i.e., RF_{A}). UHF detector 226 may detect the communication and forward the communication to UHF demodulator 228 for demodulation. UHF demodulator 228 may forward the demodulated communication to data decoder 216 for decoding. Any suitable processing may be performed on the decoded communication. A determination may be made regarding whether a response to the communication should be sent. If it is determined that a response to the communication should be sent, data encoder 214 may encode a response communication.

Depending on the frequency at which the encoded response communication should be sent, data encoder 214 may forward the encoded response communication to one of power amplifier 224, load modulator 234, or load modulator 242. If data encoder 214 forwards the encoded response communication to power amplifier 224, power amplifier 224, upon receiving a signal from signal generator 222, may forward the amplified, encoded response communication for transmission via antenna 114b at the appropriate frequency (e.g., RF_{A}). If data encoder 214 forwards the encoded response communication to load modulator 234, load modulator 234 may forward the encoded response communication for transmission via antenna 114aat the appropriate frequency (e.g., RF_{B}). If data encoder 214 forwards the encoded response communication to load modulator 242, load modulator 242 may forward the encoded response communication for transmission via data coil 240 at the LF.

In operation of another example embodiment of hybrid RFID tag 200, a communication may be received from a second tracking system at a second frequency (i.e., RF_{B}). EPC detector 230 may detect the communication and forward the communication to EPC demodulator 232 for demodulation. EPC demodulator 232 may forward the demodulated communication to data decoder 216 for decoding. Any suitable processing may be performed on the decoded communication. A determination may be made regarding whether a response to the communication should be sent. If it is determined that a response to the communication should be sent, data encoder 214 may encode a response communication.

Depending on the frequency at which the encoded response communication should be sent, data encoder 214 may forward the encoded response communication to one of power amplifier 224, load modulator 234, or load modulator 242. If data encoder 214 forwards the encoded response communication to power amplifier 224, power amplifier 224, upon receiving a signal from signal generator 222, may forward the amplified, encoded response communication for transmission via antenna 114b at the appropriate frequency (e.g., RF_{A}). If data encoder 214 forwards the encoded response communication to load modulator 234, load modulator 234 may forward the encoded response communication for transmission via antenna 114a at the appropriate frequency (e.g., RF_{B}). If data encoder 214 forwards the encoded response communication to load modulator 242, load modulator 242 may forward the encoded response communication for transmission via data coil 240 at the LF.

In operation of another example embodiment of hybrid RFID tag 200, a communication may be received from a third tracking system at a third frequency (i.e., LF). LF detector 236 may detect the communication and forward the communication to LF demodulator 238 for demodulation. LF demodulator 238 may forward the demodulated communication to data decoder 216 for decoding. Any suitable processing may be performed on the decoded communication. A determination may be made regarding whether a response to the communication should be sent. If it is determined that a response to the communication should be sent, data encoder 214 may encode a response communication.

Depending on the frequency at which the encoded response communication should be sent, data encoder 214 may forward the encoded response communication to one of power amplifier 224, load modulator 234, or load modulator 242. If data encoder 214 forwards the encoded response communication to power amplifier 224, power amplifier 224, upon receiving a signal from signal generator 222, may forward the amplified, encoded response communication for transmission via antenna 114bat the appropriate frequency (e.g., RF_{A}). If data encoder 214 forwards the encoded response communication to load modulator 234, load modulator 234 may forward the encoded response communication for transmission via antenna 114aat the appropriate frequency (e.g., RF_{B}). If data encoder 214 forwards the encoded response communication to load modulator 242, load modulator 242 may forward the encoded response communication for transmission via data coil 240 at the LF.

Although particular components of hybrid RFID tag 200 have been described with reference to FIG. 3, the present invention contemplates a hybrid RFID tag that includes fewer, additional, and/or different components. For example, although UHF, EPC, and LF components are illustrated and described, the present invention contemplates the passive RFID elements, semi-active RFID elements, and active RFID elements comprising different components than those illustrated and described in this example. A portion or all of the components of hybrid RFID tag 200 may be embodied on a single or on multiple substrates; however, for particular applications it may be desirable for the components of hybrid RFID tag 200 to be embodied on a single substrate.

Although the present invention has been described with several embodiments, diverse changes, substitutions, variations, alterations, and modifications may be suggested to one skilled in the art, and it is intended that the invention encompass all such changes, substitutions, variations, alterations, and modifications as fall within the spirit and scope of the appended claims.

What is claimed is:

1. A hybrid radio frequency identification (RFID) tag, comprising:
one or more backscattering RFID elements operable to transmit and receive communications to and from a first tag tracking system at a first frequency range, the one or more backscattering RFID elements operable to transmit communications to the first tag tracking system using backscattering of a particular communication received from the first tag tracking system;
one or more active RFID elements operable to transmit and receive communications to and from a second tag tracking system at a second frequency range and operable to transmit communications to the second tag tracking system at the second frequency range with the use of a local power supply; and
a local power supply coupled to the one or more active RFID elements.

2. The hybrid RFID tag of claim 1, wherein a particular backscattering RFID element comprises a passive RFID element operable to transmit and receive communications without the use of a local power supply associated with the passive RFID element.

3. The hybrid RFID tag of claim 1, wherein a particular active RFID element comprises a semi-active RFID element operable to:
receive the particular communication from the first tag tracking system at the first frequency, the particular communication comprising a wake-up signal; and
transmit a response communication to the particular communication using a local power supply coupled to the semi-active RFID element.

4. The hybrid RFID tag of claim 1, wherein the one or more backscattering elements comprises at least one low frequency (LF) component.

5. The hybrid RFID tag of claim 1, wherein:
a particular backscattering RFID element is operable to receive the particular communication at the first frequency range; and
a particular active RFID element is operable to transmit a response communication to the particular communication at the second frequency range.

6. The hybrid RFID tag of claim 1, wherein the first frequency range comprises a low frequency (LF).

7. The hybrid RFID tag of claim 1, wherein the first frequency range comprises a very low frequency (VLF).

8. The hybrid RFID tag of claim 1, wherein the first frequency range comprises a microwave frequency.

9. The hybrid RFID tag of claim 1, wherein the first frequency range comprises an ultra-high frequency (UHF).

10. The hybrid RFID tag of claim 1, wherein the second frequency range comprises a very high frequency (VHF).

11. The hybrid RFID tag of claim 1, wherein the second frequency range comprises an ultra-high frequency (UHF).

12. The hybrid RFID tag of claim 1, wherein a particular backscattering RFID elements is compliant with a version of the electronic product code (EPC) standard.

13. The hybrid RFID tag of claim 1, wherein the local power supply comprises a battery.

14. The hybrid RFID tag of claim 1, comprising one or more processing units, the one or more backscattering RFID elements and the one or more active RFID elements operable to share the one or more processing units of the tag for transmitting and receiving communications.

15. The hybrid RFID tag of claim 1, wherein the first and second tag tracking systems each comprise one or more of the following:
an activator operable to communicate a wake-up communication to the hybrid RFID tag; and
a tag reader operable to generate a magnetic field.

16. The hybrid RFID tag of claim 1, further comprising one or more antennas for transmitting and receiving the communications.

17. A hybrid radio frequency identification (RFID) tag, comprising:
one or more passive RFID elements operable to transmit and receive communications to and from a first tracking system at a first frequency range without the use of a local power supply;
one or more semi-active RFID elements operable to transmit and receive communications to and from a second tracking system at a second frequency range with the use of a local power supply and upon receiving a wake-up signal from the second tag tracking system; and
a local power supply coupled to the one or more semi-active elements.

18. The hybrid RFID tag of claim 17, further comprising one or more active RFID elements operable to transmit and receive communications to and from a third tracking system at a third frequency range using a local power supply coupled to the one or more active RFID elements.

19. The hybrid RFID tag of claim 17, wherein the first frequency range comprises one or more of the following:
a low frequency (LF);
a very low frequency (VLF);
a microwave frequency; and
an ultra-high frequency (UHF).

20. The hybrid RFID tag of claim 17, wherein the second frequency range comprises one or more of the following:
a low frequency (LF);
a very high frequency (VHF); and
an ultra-high frequency (UHF).

21. The hybrid RFID tag of claim 17, wherein a particular passive RFID element is compliant with a version of the electronic product code (EPC) standard.

22. The hybrid RFID tag of claim 17, wherein the local power supply coupled to the one or more semi-active RFID elements comprises a battery.

23. The hybrid RFID tag of claim 17, comprising one or more processing units, the one or more passive RFID elements and the one or more semi-active RFID elements operable to share the one or more processing units of the tag for transmitting and receiving communications.

24. A hybrid radio frequency identification (RFID) tag, comprising:
one or more electronic product code (EPC)-compliant RFID elements operable to transmit and receive communications to and from a first tag tracking system at a first frequency range without the use of a local power supply;
one or more active RFID elements operable to transmit and receive communications to and from a second tag tracking system at a second frequency range and operable to transmit communications to the second tag tracking system at the second frequency range with the use of a local power supply; and
a local power supply coupled to the one or more active elements.
